(19) United States
(12) Patent Application Publication
(10) Pub. No.: US 2021/0198023 A1
(43) Pub. Date: Jul. 1, 2021

(54) Animal Feed Container Assembly

(71) Applicant: Raymond Barker, Chicago, IL (US)

(72) Inventor: Raymond Barker, Chicago, IL (US)

(21) Appl. No.: 16/728,540

(22) Filed: Dec. 27, 2019

(51) Int. Cl. B65D 75/58; B65D 33/06

(52) U.S. Cl. CPC B65D 75/5872; A01K 5/00; B65D 33/06

(57) ABSTRACT

An animal feed container assembly includes a feed container for containing animal feed. The feed container has a dispenser extending into an interior of the feed container to pour the animal feed outwardly therefrom for feeding an animal. A door is hingedly coupled to the feed container for opening and closing the dispenser. A first handle is coupled to the feed container for gripping and a second handle is coupled to the feed container for gripping. The second handle is positioned on a different side of the feed container with respect to the first handle wherein the first handle and the second handle are configured to facilitate a user to hold the feed container at an angle for pouring the animal feed from the feed container.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to container devices and more particularly pertains to a new container device for storing and dispensing animal feed.

### (2) Description of Related Art Including Information Disclosed Under 37 CFR 1.97 and 1.98

The prior art relates to container devices.

### BRIEF SUMMARY OF THE INVENTION

An embodiment of the disclosure meets the needs presented above by generally comprising a feed container for containing animal feed. The feed container has a dispenser extending into an interior of the feed container to pour the animal feed outwardly therefrom for feeding an animal. A door is hingedly coupled to the feed container for opening and closing the dispenser. A first handle is coupled to the feed container for gripping and a second handle is coupled to the feed container for gripping. The second handle is positioned on a different side of the feed container with respect to the first handle wherein the first handle and the second handle are configured to facilitate a user to hold the feed container at an angle for pouring the animal feed from the feed container.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an animal feed container assembly according to an embodiment of the disclosure.

FIG. 2 is a top view of an embodiment of the disclosure.

FIG. 3 is a front view of an embodiment of the disclosure.

FIG. 4 is a right side view of an embodiment of the disclosure.

FIG. 5 is a perspective in-use view of an embodiment of the disclosure.

### DETAILED DESCRIPTION OF THE INVENTION

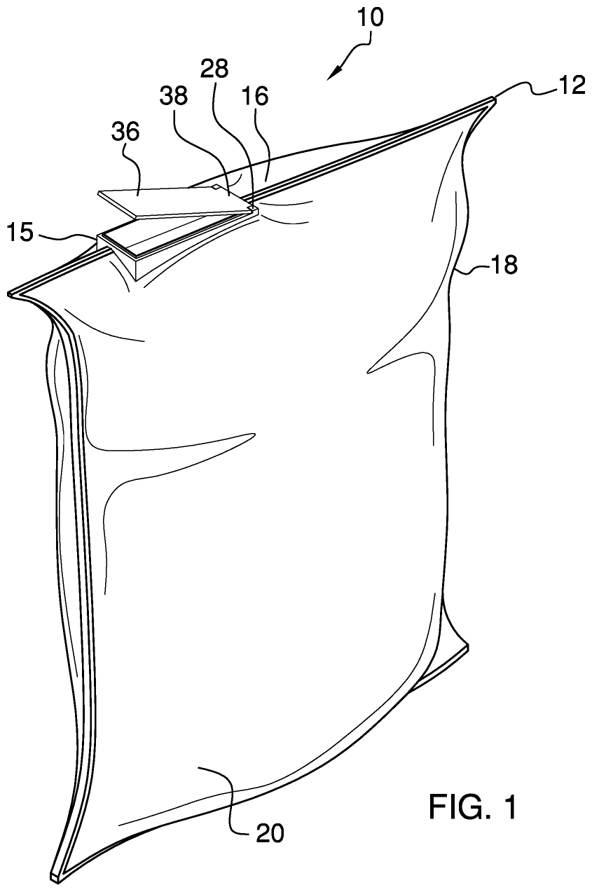

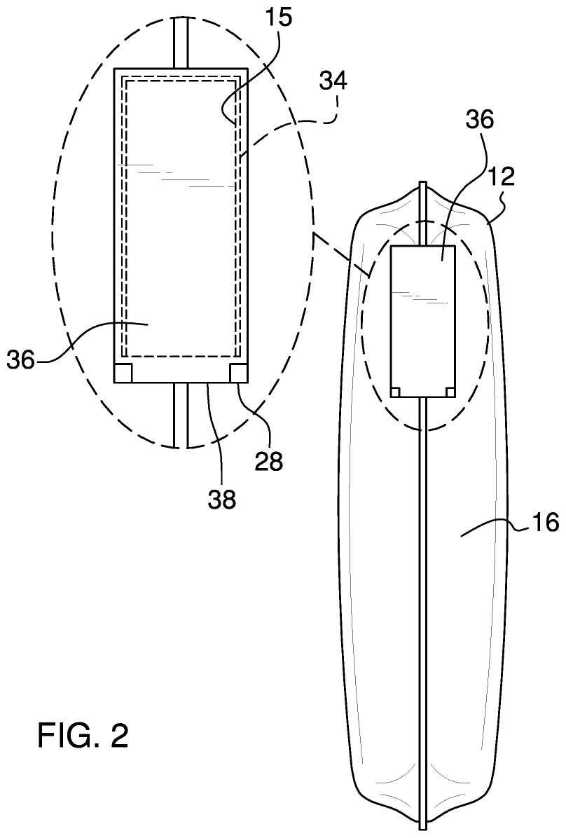

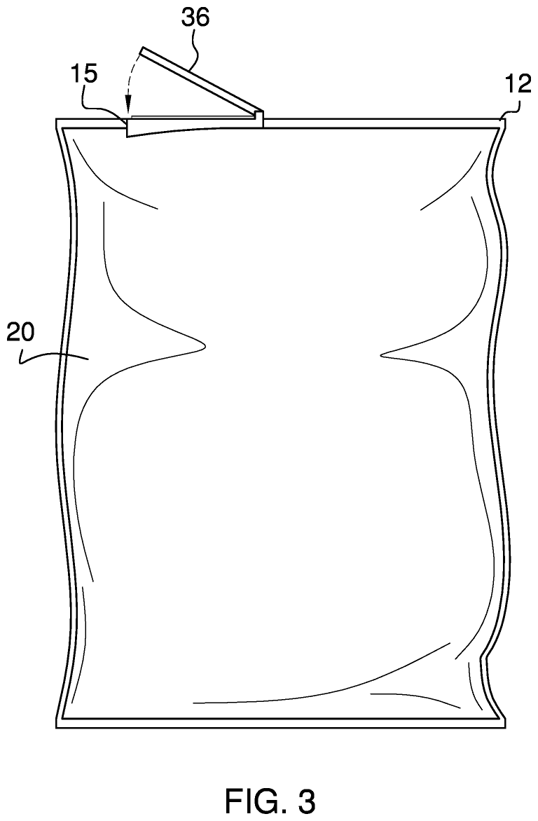

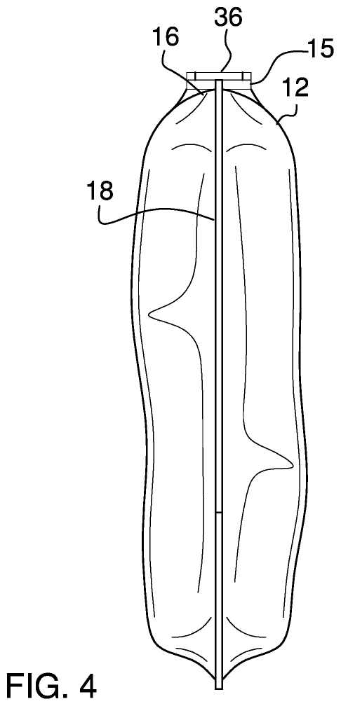

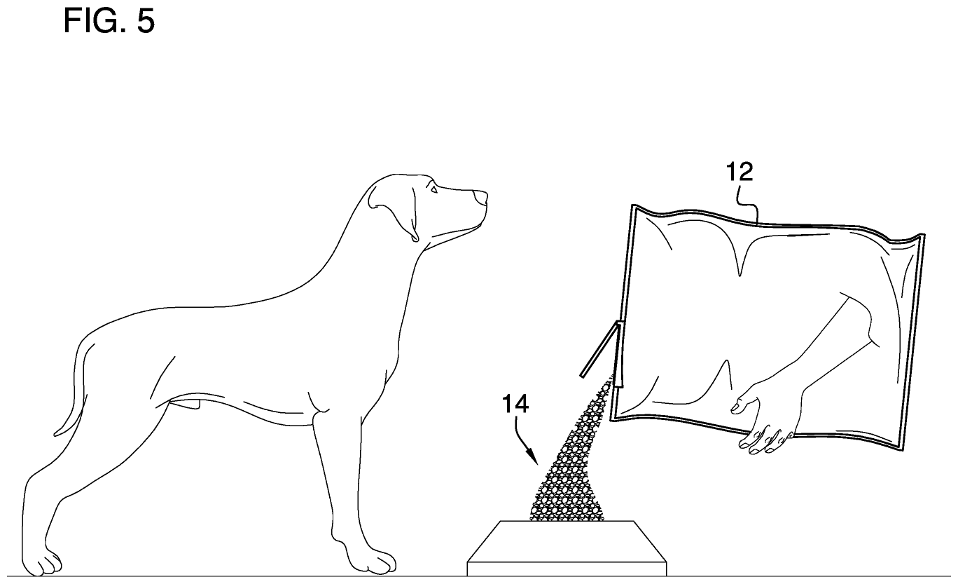

With reference now to the drawings, and in particular to FIGS. 1 through 5 thereof, a new container device embodying the principles and concepts of an embodiment of the disclosure and generally designated by the reference numeral 10 will be described.

As best illustrated in FIGS. 1 through 5, the animal feed container assembly 10 generally comprises a feed container 12 for containing animal feed 14. The animal feed 14 may be dry dog food, dry cat food or any other type of dry, granular animal feed. Additionally, the feed container 12 may comprise a bag similar in construction to existing dog food bags or cat food bags. The feed container 12 has a dispenser 15 extending into an interior of the feed container 12 to pour the animal feed 14 outwardly therefrom for feeding an animal. The animal may be a dog, a cat or any other domesticated animal.

The feed container 12 has a top side 16, a first lateral side 18 and a front side 20. The dispenser 15 extends through the top side 16 and the dispenser 15 has a back side 28. The front side 20 has indicia 32 printed thereon and the indicia 32 may comprise words describing the contents of the feed container 12, a company logo, an image or any other indicia 32 associated with animal feed 14.

A membrane 34 is removably coupled to the feed container 12 and the membrane 34 covers the dispenser 15. The membrane 34 is comprised of a fluid impermeable material to inhibit air from entering the feed container 12 thereby enhancing freshness of the animal feed 14. Moreover, the membrane 34 is removable from the dispenser 15 to facilitate the animal feed 14 to be dispensed through the dispenser 15. The membrane 34 may be adhered to the feed container 12 or the membrane 34 may be removably retained on the feed container 12 in any suitable manner. Additionally, the membrane 34 may be comprised of foil or the like.

A door 36 is provided and the door 36 is hingedly coupled to the feed container 12. The door 36 covers the dispenser 15 when the door 36 is in a closed positioned. Conversely, the dispenser 15 is uncovered when the door 36 is opened. The door 36 has a rear edge 38 and the rear edge 38 is hingedly coupled to the back side 28 of the dispenser 15. The door rests on top of the dispenser when the door is closed

A first handle 46 is coupled to the feed container 12 for gripping and the first handle 46 is positioned on the top side 16 of the feed container 12. The first handle 46 may have a first end 48 and a second end 50, and each of the first end 48 and the second end 50 may be attached to the top side 16 having the first handle 46 forming an arc.

A second handle 52 is coupled to the feed container 12 for gripping. The second handle 52 is positioned on a different side of the feed container 12 with respect to the first handle 46. In this way the first handle 46 and the second handle 52 are facilitate a user to hold the feed container 12 at an angle for pouring the animal feed 14 from the feed container 12. The second handle 52 is positioned on the first lateral side 18 of the feed container 12. Additionally, the second handle 52 may have a primary end 54 and a secondary end 56, and each of the primary end 54 and the secondary end 56 may be attached to the first lateral side 18 of the feed container 12 having the second handle 52 forming an arc.

In use, the door 36 is opened and the membrane 34 is removed from the feed container 12. In this way the dispenser 15 is exposed for pouring a measured amount of the animal feed 14 from the feed container 12. Each of the first handle 46 and the second handle 52 are gripped for tilting the feed container 12 and subsequently pouring the measured amount of the animal feed 14 from the feed container 12. The door 36 is closed when the measured amount of animal feed 14 has been poured to close the dispenser 15, thereby retaining freshness of the animal feed 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An animal feed container assembly being configured to store animal feed in an air tight container until said assembly is opened for subsequently dispensing the animal feed, said assembly comprising:
a feed container containing animal feed, said feed container having a dispenser extending into an interior of said feed container wherein said dispenser is configured to pour the animal feed outwardly therefrom for feeding an animal, said feed container having a top side, a first lateral side and a front side, said dispenser extending through said top side, said dispenser having a back side, said top side comprising a linear junction of said front side of said feed container and a rear side of said feed container, said dispenser comprising a rectangular opening elongated parallel to the top side, said rectangular opening being spaced above said top side, said dispenser having a planar front face opposite said back side of said dispenser, said front face being planar and having a bottom notch, said linear junction being positioned at an apex of said bottom notch, said bottom notch having straight edges extending away from said apex, each of said front side of said feed container and said rear side of said feed container extending along a respective one of said straight edges of said bottom notch;
a door being hingedly coupled to said feed container, said door covering said dispenser when said door is in a closed positioned, said door uncovering said dispenser when said door is in an open position.

2. (canceled)

3. The assembly according to claim 1, further comprising a membrane being removably coupled to said feed container, said membrane covering said dispenser, said membrane being comprised of a fluid impermeable material wherein said membrane is configured to inhibit air from entering said feed container thereby enhancing freshness of the animal feed, said membrane being removable from said dispenser to facilitate the animal feed to be dispensed through said dispenser.

4. The assembly according to claim 3, wherein said door has a rear edge, said rear edge being hingedly coupled to said back side of said dispenser.

5. (canceled)

6. An animal feed container assembly being configured to store animal feed in an air tight container until said assembly is opened for subsequently dispensing the animal feed, said assembly comprising:
a feed container containing animal feed, said feed container having a dispenser extending into an interior of said feed container wherein said dispenser is configured to pour the animal feed outwardly therefrom for feeding an animal, said feed container having a top side, a first lateral side and a front side, said dispenser extending through said top side, said dispenser having a back side, said feed container having a top side, a first lateral side and a front side, said top side comprising a linear junction of said front side of said feed container and a rear side of said feed container, said dispenser comprising a rectangular opening elongated parallel to the top side, said rectangular opening being spaced above said top side, said dispenser being positioned along said top side offset from a center of said top side, said dispenser having a planar front face opposite said back side of said dispenser, said front face being planar and having a bottom notch, said linear junction being positioned at an apex of said bottom notch, said bottom notch having straight edges extending away from said apex, each of said front side of said feed container and said rear side of said feed container extending along a respective one of said straight edges of said bottom notch;
a membrane being removably coupled to said feed container, said membrane covering said dispenser, said membrane being comprised of a fluid impermeable material wherein said membrane is configured to inhibit air from entering said feed container thereby enhancing freshness of the animal feed, said membrane being removable from said dispenser to facilitate the animal feed to be dispensed through said dispenser; and
a door being hingedly coupled to said feed container, said door covering said dispenser when said door is in a closed positioned, said door exposing said dispenser when said door is in an open position, said door having a back edge, said back edge being hingedly coupled to said back side of said dispenser, said back edge being positioned facing the center of said top side of said feeding container wherein said dispenser opens away from said first lateral side of said feed container.
